(19) United States
(12) Patent Application Publication
(10) Pub. No.: US 2023/0275478 A1
(43) Pub. Date: Aug. 31, 2023

(54) Rotor and Electrical Machine

(71) Applicant: Scania CV AB, Södertälje (SE)

(72) Inventor: Jörgen Engström, Grödinge (SE)

(21) Appl. No.: 18/019,705

(22) PCT Filed: Jul. 8, 2021
(86) PCT No.: PCT/SE2021/050695

§ 371 Date: Feb. 3, 2023

(30) Foreign Application Priority Data
Aug. 11, 2020 (SE) 2050943-6

(51) Int. Cl. H02K 1/276

(52) U.S. Cl. CPC H02K 1/276; H02K 29/03

(57) ABSTRACT

An electrical machine comprising a rotor and a stator. The rotor comprises at least one permanent magnet; at least one magnet slot interior to the rotor, configured to hold the permanent magnet, which magnet slot comprises at least one end portion at a rotor surface of the rotor; at least one magnet bridge arranged in the rotor surface, configured to cover the end portion of the magnet slot; and at least one axially extending groove in the rotor surface, arranged adjacent to the at least one magnet bridge.

### TECHNICAL FIELD

This document discloses a rotor of a permanent magnet electrical machine. More particularly, a rotor is presented, having reduced iron loss and reduced heat development in comparison with prior art solutions. This document further discloses an electrical machine and a vehicle comprising an electrical machine.

### BACKGROUND

Modern electric machines such as electric motors, generators and/or alternators often use permanent magnets comprised in a rotor which is rotating in a stator in order to achieve required performance. A relatively high power in limited machine size is hereby achieved. As the rotor rotates in synchronism with the stator field in the stator and as there are no currents in the rotor, the rotor losses are typically very low.

However, at the rotor surface there will be losses induced due to field variations that origins from the varying reluctance caused by the stator slots. This effect is sometimes referred to as cogging or cogging torque. This is especially pronounced in electric machines comprising a stator using open slots.

The losses induced in the rotor are dependent on rotation frequency and are more evident at higher speeds. They may or may not be a substantial part of the total losses. But even if they are not important for the overall efficiency, there can still be a severe problem with heating of the rotor which is a problem for the magnets. Magnets in general are sensitive for heat exposure and may lose their magneticity. To overcome this, permanent magnets which are particularly dedicated for high temperatures may be utilised; these magnets are however expensive.

Also, the varying reluctance of the stator slots as the rotor turns around cause the torque produced by the rotor to variate, i.e. causes a cogging torque. This phenomenon is also related to the stator slot openings and the interaction with the magnets of the rotor.

It would be desired to find a solution addressing at least some of the above issues and reduce losses of the rotor and heating of the rotor caused by the losses.

### SUMMARY

It is therefore an object of this invention to solve at least some of the above problems and improve a permanent magnet electrical machine, in particular the rotor thereof.

According to an aspect of the invention, this objective is achieved by a rotor of an electrical machine. The rotor comprises at least one permanent magnet interior to the rotor. Further, the rotor comprises at least one magnet slot arranged between an end portion of the permanent magnet and a rotor surface. The rotor also comprises at least one magnet bridge arranged in the rotor surface, configured to cover the magnet slot. The rotor also comprises at least one axially extending groove in the rotor surface, arranged adjacent to at least one magnet bridge.

By providing the axially extending groove in the rotor surface, losses of the rotor are reduced, leading to less heat development. Energy is thereby saved, but perhaps more important, permanent magnets with a lower temperature grade (than in conventional solutions) can be used, leading to reduced costs, as these magnets in general are less costly. Possibly, also a more efficient rotor/electrical machine is provided, besides being cheaper, in case certain type of permanent magnets (Neodymium magnets or similar) are applied.

Further, reduced losses and heat development leads to extended lifetime of the rotor/electrical machine as the thermal robustness of the magnets is improved thanks to the effect caused by the introduced rotor grooves.

Another advantage of reducing the loss of the rotor is that noise and/or vibrations of the rotor is eliminated or at least reduced, thereby improving the ergonomic driving conditions of the driver and/or passenger/s of the vehicle.

Other advantages and additional novel features will become apparent from the subsequent detailed description.

### FIGURES

Embodiments of the invention will now be described in further detail with reference to the accompanying figures, in which:

FIG. 1 illustrates an electric machine comprising a rotor according to an embodiment, comprising a single V magnet configuration.

FIG. 2 illustrates a rotor comprising a double V magnet configuration according to an embodiment.

FIG. 3 illustrates a rotor comprising a D magnet configuration according to an embodiment.

FIG. 4 illustrates a vehicle comprising a rotor and an electric machine according to an embodiment.

### DETAILED DESCRIPTION

Embodiments of the invention described herein are defined as a rotor, an electrical machine comprising the rotor and a vehicle comprising the electrical machine which may be put into practice in the embodiments described below. These embodiments may, however, be exemplified and realised in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

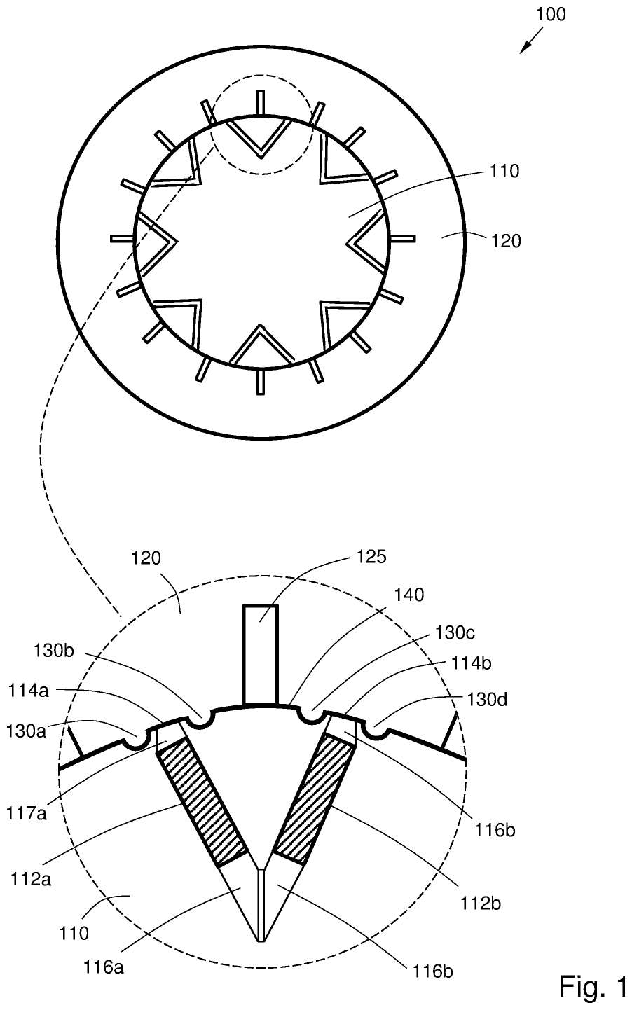

FIG. 1 illustrates a permanent magnet electrical machine 100 comprising a rotor 110 and a stator 120.

The electrical machine 100 may be configured for converting electrical energy into mechanical energy thereby operating as an electric motor. The electrical machine 100 may also, or alternatively comprise an electric generator, which has the same configuration as an electric motor but operates with a reversed flow of power, converting mechanical energy into electrical energy.

The electrical machine 100 may be comprised in a vehicle and be configured to propel the vehicle while driving thereby operating as an electric motor. In case the vehicle is driving down-hill and/or braking, the electrical machine 100 instead may operate as an electric generator, generating electricity which may be stored in a battery.

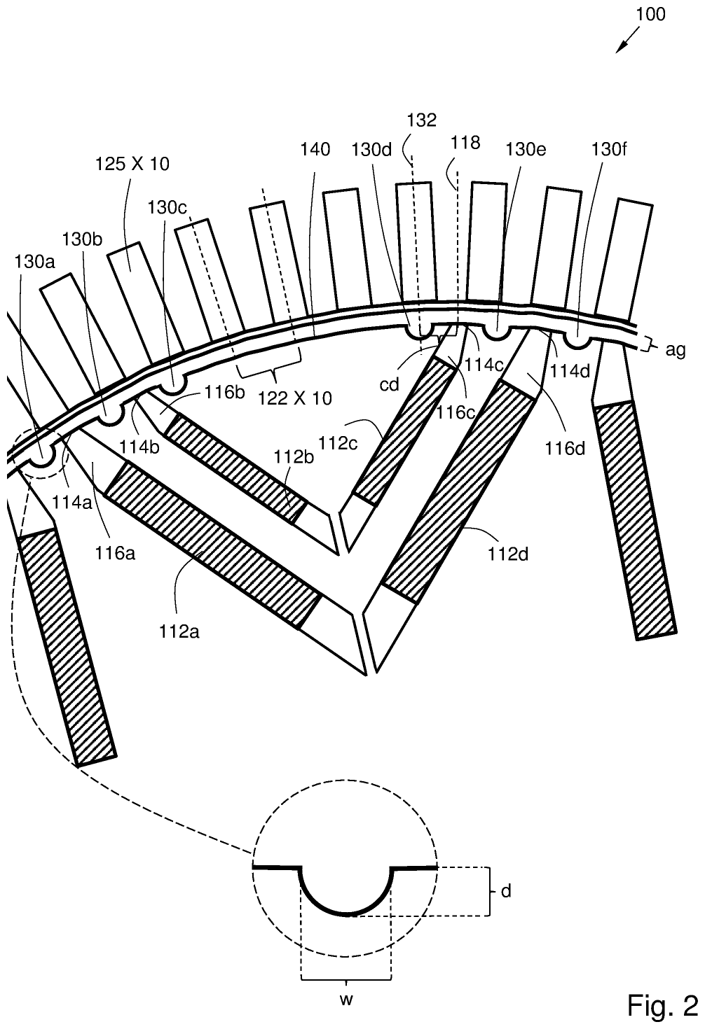

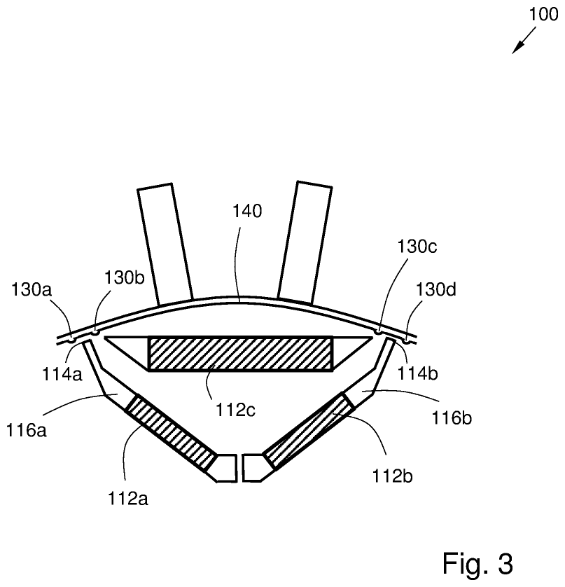

The rotor 110 has a structure with interior permanent magnets 112a, 112b, each comprising two opposite poles, typically one N pole and one S pole situated in a respective opposite end portion of each magnet 112a, 112b. The magnets 112a, 112b may be applied within the rotor 110 in different configurations, such as for example single V configuration as, double V configuration as illustrated in FIG. 2, triple V configuration, quadruple V configuration, D configuration as illustrated in FIG. 3, etc. Although different magnet configurations and/or different numbers of magnets 112a, 112b may be applied, the general principle of the functionality remains the same. When the magnets 112a, 112b are applied in a single V configuration as, double V configuration, etc., the magnets 112a, 112b may be arranged with the respective identical poles facing each other, such as e.g. the N pole of the first magnet 112a and the N pole of the second magnet 112b. Alternatively, another arrangement may be made, such as e.g. the S pole of the first magnet 112a and the S pole of the second magnet 112b.

The stator 120 is enclosing the rotor 110 and comprises a number of slots 125. The stator slots 125 may be open, closed or semi-closed in different embodiments. The open stator slot 125 may have substantially flat walls extending to a radially inner delimiting surface of the stator 120. In other embodiments, the walls of the open stator slot 125 may have other configurations, e.g. a convex/concave profile, an oval profile, etc. Open stator slots 125 are easily implemented. In the open stator slots 125, assembly and repair of winding are easy.

The semi-closed stator slot 125 comprises a neck formation limiting the exposure of the slot 125 towards the rotor 110. The slot opening is much smaller than the width of the slot 125. However, air gap characteristics are advantageous in comparison with open stator slots.

The closed stator slot 125 may comprise a closed cavity in the stator 120. The closed stator slots 125 are designed to cause saturation, to keep the permeability low. This reduces the slot harmonics in the magnetic flux density but will also increase the flux leakage between the stator teeth.

The magnets 112a, 112b, are situated in magnet slots 116a, 116b internal to the rotor 110. The magnet slots 116a, 116b comprises at least one end portion 117a, 117b at a rotor surface 140 of the rotor 110. The end portion 117a, 117b of the magnet slot 116a, 116b is the interruption of the extension of the magnet slot 116a, 116b, situated in a region of the rotor surface 140. The rotor surface 140 is circumventing the rotor 100.

Also, a magnet bridge 114a, 114b is covering the respective end portion 117a, 117b of the magnet slot 116a, 116b. An outer surface of the magnet bridge 114a, 114b may form part of the rotor surface 140, circumventing the rotor 100. The rotor 110 is rotatably disposed on an inward side of the stator 120 with an air gap distance between the rotor surface 140 and the stator 120, creating a radial clearance distance between the rotor 110 and the stator 120. Thus, the rotor 110 forms a rotating part of the electrical machine 100 while the stator 120 forms a stationary part of the electrical machine 100.

The magnets 112a, 112b comprised within the rotor 110 creates a magnetic field which, when rotating, generates electrical current due to induction, when the electrical machine 100 operates in generator mode.

It has been detected that by removing material on the rotor surface 140 at locations where excess losses are estimated to occur, the rotor losses as well as heat development are greatly reduced.

In the illustrated example a number of axially extending grooves 130a, 130b, 130c, 130d in the rotor surface 140. One or several grooves 130a, 130b, 130c, 130d may be prepared and applied close to at least one of the magnet bridges 114a, 114b. The grooves 130a, 130b, 130c, 130d may be extending axially along the rotor 110 in the rotor surface 140, in a direction coinciding with the rotation axis of the rotor 110.

The losses induced in the rotor 110 are located to the rotor surface 140 in the direction coinciding with the rotation axis of the rotor 110. By arranging the grooves 130a, 130b, 130c, 130d in the direction of the rotation axis, losses are reduced.

One groove 130a, 130b, 130c, 130d may be arranged on each side of the magnet bridge 114a, 114b, 114c, 114d of the rotor 110 in some embodiments. An advantage therewith is that losses are reduced independently on rotation direction of the rotor 110, so that the electrical machine 100 may swap usage between operating in motor mode and generator mode, yet achieving reduced losses independent of usage mode.

In some embodiments, the grooves 130a, 130b, 130c, 130d may be arranged symmetrically on each side of each magnet bridge 114a, 114b, 114c, 114d of the rotor 110 meaning that the grooves 130a, 130b, 130c, 130d may be arranged at substantially the same respective distances to the respective magnet bridge 114a, 114b, 114c, 114d. Thereby, losses are reduced substantially equally, independently on rotation direction of the rotor 110, i.e. usage mode of the electrical machine 100.

In some embodiments, at least about 50% of the magnet bridges 114a, 114b, 114c, 114d of the rotor 110 may have a groove 130a, 130b, 130c, 130d arranged on each side of it. In some embodiments, all of the magnet bridges 114a, 114b, 114c, 114d of the rotor 110, or substantially all of them, may have a groove 130a, 130b, 130c, 130d arranged on each side of it.

The rotor 110 is thereby configured for reducing heat development of the permanent magnet 112a, 112b, 112c, 112d interior to the rotor 110. With the introduced grooves 130a, 130b, 130c, 130d the rotor iron loss is reduced, at 7000 rpm by 50% in some embodiments. Also winding losses are slightly reduced.

Possibly, the grooves 130a, 130b, 130c, 130d on the rotor surface 140 also provide a cooling effect on the rotor 110 as the rotor surface 140 becomes larger, i.e. the heat of the rotor 110 is distributed over a larger surface area. Also, the grooves 130a, 130b, 130c, 130d to some extend may enable air flow in the air gap between rotor 110 and stator 120.

By reducing the losses, less heat is created in the rotor 110, which makes it possible to use less sophisticated (and thereby cheaper) permanent magnets, i.e. magnets that are more sensitive to high temperatures may be used, in comparison with a prior art rotor without the grooves 130a, 130b, 130c, 130d according to the present disclosure.

Further, another type of permanent magnets may be used, such as Neodymium magnets. Neodymium magnets have higher remanence, much higher coercivity and energy product, than other types of magnets, but unfortunately have a tendency to lose their magnetism when heated, at a lower temperature than most other types of permanent magnets. Remanence is a measure of the strength of the magnetic field of the magnet, coercivity is the material's resistance to becoming demagnetised for other reasons than heating, for example by a sudden impact. Thereby, a more efficient rotor 110/electrical machine 100 can be provided by using for example Neodymium magnets, besides being cheaper (in comparison with conventional solutions), in some embodiments.

Reduced heat development leads to saved money. The lifetime of the rotor 110/electrical machine 100 is also extended as the thermal robustness of the magnets 112a, 112b is improved thanks to the effect caused by the rotor grooves 130a, 130b, 130c, 130d.

Another advantage of reducing the loss of the rotor 110 is that noise and/or vibrations of the rotor 110 is eliminated or at least reduced, thereby improving the ergonomic driving conditions of the driver and/or passenger of the vehicle 100.

The V-shape formation of the magnets 112a, 112b in the rotor 110 seems to utilise more magnetic flux than the other shapes, according to some tests. This indicates that the V-shape using a small amount of current is suitable for generating high power. Moreover, as the V-shape has a more sinusoidal waveform than the D-shape formation of the magnets 112a, 112b, it likely is more advantageous for minimising torque ripples.

FIG. 2 illustrates a permanent magnet electrical machine 100 comprising a rotor 110 and a stator 120. A set of permanent magnets 112a, 112b, 112c, 112d are arranged in a double V configuration interior to the rotor 110 in the illustrated embodiment. The double V configuration means that permanent magnets 112a, 112b, 112c, 112d forms an inner V, arranged within an outer V, also formed by magnets 112a, 112b, 112c, 112d.

The magnets 112a, 112b, 112c, 112d are arranged in a respective magnet slot 116a, 116b, 116c, 116d arranged between an end portion of the permanent magnet 112a, 112b, 112c, 112d and a rotor surface 140.

A magnet bridge 114a, 114b, 114c, 114d is arranged in the rotor surface 140, configured to cover the respective magnet slot 116a, 116b, 116c, 116d. Also, the rotor 110 comprises at least one axially extending groove 130a, 130b, 130c, 130d in the rotor surface 140, arranged adjacent to at least one magnet bridge 114a, 114b, 114c, 114d.

The depth d of the groove 130a, 130b, 130c, 130d may in some embodiments be substantially equal to an air gap length ag between the rotor surface 140 and the stator 120, which is operating in conjunction with the rotor 110. Thus, the depth d may be about: 0.8·(air gap length)<depth d<1.2·(air gap length); or 0.95·(air gap length)<depth d<1.05·(air gap length) in different embodiments. The depth d of the groove 130a, 130b, 130c, 130d, as well as the air gap length ag between the rotor surface 140 and the stator 120, may be measured radially in a plane perpendicular to the rotational axis of the rotor 110.

The air gap length ag between the rotor surface 140 and the stator 120 is proportional to fixed losses of the electrical machine 100. Thus, an increase in the air gap length ag leads to increased fixed losses. It is typically desired to keep the air gap length ag and thereby also the fixed losses as low as possible.

The size of the air gap length ag is critical from an efficiency point of view, for the electrical machine 100. The larger the air gap length ag is, the less efficient the electrical machine 100 will be. The depth d of the groove 130a, 130b, 130c, 130d is a balance between desiring to reduce as much material from the surface, i.e. large depth d of the groove 130a, 130b, 130c, 130d (for reducing losses and heat development), and minimised air gap length ag (for keeping the electrical machine 100 as efficient as possible). The size of the depth d of the groove 130a, 130b, 130c, 130d will increase an “average” air gap length ag around the rotor 110. This is probably also the reason why the herein presented invention has never been introduced before, i.e. the focus of the skilled person is typically to enhance efficiency of the electrical machine 100 by minimising the air gap length ag, an action which is contravened by the introduced groove 130a, 130b, 130c, 130d. By designing the depth d of the axially extending groove 130a, 130b, 130c, 130d substantially equal to the air gap length ag, a balance between efficiency of the electrical machine 100 and reduced losses/heat development of the rotor 110 is achieved.

The width w of the groove 130a, 130b, 130c, 130d may be substantially equal to a stator slot pitch 122 of the stator 120 in some embodiments. The stator slot pitch 122 is the distance between the stator slots 125, as illustrated in FIG. 2, in tangential direction. The width w of the groove 130a, 130b, 130c, 130d may be about: 0.8·(slot pitch distance)<w<1.2·(slot pitch distance); or 0.95·(slot pitch distance)<w<1.05·(slot pitch distance) in different embodiments. The width w of the groove 130a, 130b, 130c, 130d may be measured tangential to the surface 140 of the rotor 110.

Again, the design of the groove 130a, 130b, 130c, 130d is a balance between efficiency of the electrical machine 100 and reduced losses/heat development of the rotor 110. By designing the width w of the groove 130a, 130b, 130c, 130d substantially equal to the stator slot pitch 122 of the stator 120, as may be made in some embodiments, this balance is achieved.

In the illustrated example, the groove 130a, 130b, 130c, 130d has an arc shape profile in a plane perpendicular to the rotation axis of the rotor 110. Hereby, easily implemented formation of the groove 130a, 130b, 130c, 130d is provided.

However, in other embodiments, the groove 130a, 130b, 130c, 130d may have another shape profile such as for example parallelepipedal, quadratic, rectangular, etc.

The provided solution can easily be implemented since it can be done by adjusting the cutting/stamping of laminates forming the rotor surface 140 of the rotor 110.

A centre axis 132 of the axially extending groove 130a, 130b, 130c, 130d may be situated at a circumferential distance cd from a centre axis 118 of the magnet bridge 114a, 114b, 114c, 114d in some embodiments, in an interval 0≤the circumferential distance≤2·air gap length.

Practical experimentations have revealed that the placement of the axially extending groove 130a, 130b, 130c, 130d in the interval 0≤the circumferential distance≤2·the air gap length is optimal for reducing losses/heat development.

FIG. 3 illustrates yet an embodiment of a permanent magnet electrical machine 100 comprising a rotor 110 and a stator 120. A set of permanent magnets 112a, 112b, 112c are arranged in a D-configuration interior to the rotor 110. The D-configuration means that magnets 112a, 112b, 112c are arranged in a triangle-like formation.

In this embodiment, a respective groove 130a, 130b, 130c, 130d may be applied adjacent to a magnet bridge 114a, 114b. In the illustrated embodiment, one groove 130a, 130b, 130c, 130d is applied on each side of the magnet bridges 114a, 114b.

Analysis has demonstrated that the D-configuration has a higher torque than other configurations of magnets 112a, 112b, 112c because of its large magnet volume. It also has the widest magnet surface to generate an active magnetic flux. Mechanical power output is calculated based on the torque and speed required, thus the D-configuration may be a suitable design when high power output and high efficiency of the electrical machine 100 is desired.

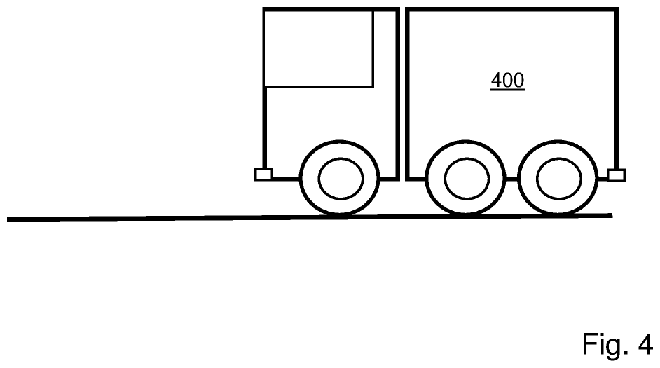

FIG. 4 illustrates a vehicle 400 comprising an electrical machine 100.

The vehicle 400 may be driver controlled or driverless autonomously controlled in different embodiments. The vehicle 400 may comprise a means for transportation in broad sense such as e.g. a truck, a car, a motorcycle, a trailer, a bus, a bike, a train, a tram, an aircraft, a watercraft, an unmanned underwater vehicle, a drone, a humanoid service robot, a spacecraft, or other similar manned or unmanned means of conveyance running e.g. on wheels, rails, air, water, intergalactic space or similar media.

The vehicle 400 may be an electric vehicle, a hybrid vehicle, a plug-in hybrid vehicle, etc., wherein the electrical machine 100 is configured for propelling the vehicle 400, for generating electrical energy for the vehicle 400 to use, or both depending on mode: motor mode or generator mode.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. The mere fact that certain measures are recited in mutually different dependent claims does not indicate that a combination of these measures cannot be used to advantage.

1. A rotor for an electrical machine, the rotor comprising:
at least one permanent magnet;
at least one magnet slot interior to the rotor, configured to hold the permanent magnet, which magnet slot comprises at least one end portion at a rotor surface of the rotor;
at least one magnet bridge arranged in the rotor surface, configured to cover the end portion of the magnet slot; and
at least one axially extending groove in the rotor surface, arranged adjacent to the at least one magnet bridge.

2. The rotor according to claim 1, wherein one axially extending groove is arranged on each side of the magnet bridge of the rotor.

3. The rotor according to claim 1, wherein one axially extending groove is arranged symmetrically on each side of each magnet bridge of the rotor.

4. The rotor according to claim 1, wherein a depth of the axially extending groove is substantially equal to an air gap length between the rotor surface and a stator operating in conjunction with the rotor.

5. The rotor according to claim 1, wherein a width of the axially extending groove is substantially equal to a stator slot pitch of the stator.

6. The rotor according to claim 1, wherein the axially extending groove has an arc shape profile.

7. The rotor according to claim 1, wherein a centre axis of the axially extending groove is situated at a circumferential distance from a centre axis of the magnet bridge in an interval 0≤the circumferential distance≤2·an air gap length between the rotor surface and a stator operating in conjunction with the rotor.

8. The rotor according to claim 1, which comprises an n×V-shape magnet configuration, wherein n is an arbitrary integer between 1 and ∞.

9. The rotor according to claim 1, which comprises a D-shape magnet configuration.

10. An electrical machine, comprising:
a rotor according to claim 1; and
a stator, configured to operate in conjunction with the rotor.

11. The electrical machine according to claim 10, wherein the stator comprises open slots.

12. The electrical machine according to claim 10, wherein the stator comprises closed slots.

13. A vehicle comprising an electrical machine according to claim 10.
